(19) United States
(12) Patent Application Publication
(10) Pub. No.: US 2013/0103798 A1
(43) Pub. Date: Apr. 25, 2013

(54) LAUNCHING SESSIONS ON A COMMUNICATION SERVER

(71) Applicant: France Telecom, Paris (FR)

(72) Inventors: Zaher El Chami, Paris (FR); Guillaume Despax, Cesson Sevigne (FR)

(73) Assignee: FRANCE TELECOM, Paris (FR)

(21) Appl. No.: 13/658,925

(22) Filed: Oct. 24, 2012

(30) Foreign Application Priority Data
Oct. 25, 2011 (FR) 11 59677

(51) Int. Cl. G06F 15/16

(52) U.S. Cl. 709/217

(57) ABSTRACT

A method for creating a plurality of multimedia sessions between a first user and a second user, a first multimedia session being set up between the first and second users via a first server. The method comprises the following steps implemented by a second server: receiving a connection request from a first terminal of the first user comprising an identifier of the first user; transmitting the identifier of the first user to the first server in order to request at least an identifier of a user sharing the first multimedia session with the first user via the first server; receiving from the first server at least an identifier of said second user; and creating a second multimedia session between the first terminal of the first user and a second terminal of the second user via the second server.

### CROSS-REFERENCE TO RELATED PATENT APPLICATION

This application claims the benefit of French Patent Application No. 11 59677, filed on Oct. 25, 2011, in the French National Institute of Industrial Property, the entire contents of which is incorporated herein by reference.

### BACKGROUND

The present invention relates to the creation of multimedia sessions between different users.

The creation and the setting-up of a game section including a plurality of gamers (or users) connected via an IP network is generally done manually, at the initiative of one of the users, called “host” or “master”. This host user, connected online to a given game server, initiates a multi-player game session and assigns it an identifier, denoted X hereinbelow. The users, called “invited” or “slave” wanting to join the session initiated by the host user, connect online to the same game server, access a space dedicated to the multi-player sessions and select the session X.

Thus, when the number of multi-player sessions of the space of a game is small, the path of the client is relatively simple, assuming that the host user controls the creation and the initiation of a multi-player session which may be different from one game to another and from one game platform to another.

However, when the number of simultaneous multi-player sessions increases, the search for a given session becomes complicated. In practice, the invited players have to search for the session X from among thousands of initiated sessions, which considerably slows down the setting-up of the multi-player session, all the more so since some multi-player sessions do not incorporate any search engine making it possible to access the session X more rapidly.

Moreover, the host user has to communicate, via any communication means, an identifier of the session that he or she has created, to the invited users, in order for them to be able to join the multi-player session. In some cases, the host user also has to create a code, which is conditional for the access to the session X. This code therefore also has to be communicated to the invited players in order for them to be able to join the session X.

The same limitations appear in the context of the creation of sharing sessions, such as sessions for sharing photos, videos or music for example.

### SUMMARY

The present invention improves the situation.

A first aspect of the invention relates, to this end, to a method for creating a plurality of multimedia sessions between a first and a second user, a first multimedia session being set up between the first and second users via a first server. The method comprises the following steps implemented by a second server:
receiving a connection request from a first terminal of the first user comprising an identifier of the first user;
transmitting the identifier of the first user to the first server in order to request at least an identifier of a user sharing the first multimedia session with the first user via the first server;
receiving from the first server at least an identifier of the second user; and
creating a second multimedia session between the first terminal of the first user and a second terminal of the second user via the second server.

Thus, the method according to the invention advantageously makes it possible to initiate a plurality of multimedia sessions, from a multimedia session initially in progress between two users, and do so in a way that is transparent to the user. Indeed, the identifiers of the users are communicated directly between two servers without requiring the intervention of the users. The expression “multimedia session” should be understood to mean any sharing, communication or even game session. The user terminals may be a desktop computer, a laptop computer, a mobile telephone such as a Smartphone, a PDA (Personal Digital Assistant), or even a game console allowing access to a network.

According to certain embodiments, the identifier of the second user is received if the first session is active.

Thus, before transmitting identifiers of users in order to open a second session, the first server can check a status of the first session. For example, if one of the users has a “busy”, “absent” or even “offline” status (for example when the first server is an instant messaging server), the creation of the second session can be interrupted.

In certain embodiments of the invention, the step of creation of a second multimedia session between the first terminal and the second terminal via the second server may comprise:
transmitting the identifier of the second user to the first terminal in order to determine whether the first user wants to set up a multimedia session with the second user via the second server;
creating a second multimedia session between the first terminal and the second terminal via the second server.

The creation of the second session may then be conditional on the acceptance of the first user to set up a multimedia session with the second user via the second server.

These embodiments thus make it possible to condition the creation of the second session on the acceptance of the first user to set up a new session with the second user. For example, a pop-up window may appear on the first terminal of the first user transmitting to him the identifier of the second user in order to check whether he or she wants or does not want to set up a second session with that user.

According to certain embodiments, the creation of the second multimedia session between the first terminal and the second terminal via the second server may be conditional on the reception by the second server of a connection request from the second terminal comprising an identifier of the second user.

Thus, the first terminal can be set to standby while the second terminal connects to the second server before setting up the second session.

In addition, on reception of the connection request from the second terminal comprising an identifier of the second user, the method also comprises the transmission of the identifier of the first user to the second terminal in order to determine whether the second user wants to set up a multimedia session with the first user via the second server and creating a second multimedia session between the first terminal and the second terminal via the second server is conditional on the acceptance of the second user to set up a multimedia session with the first user via the second server.

Thus, symmetrically, the second user can also accept or reject the setting-up of the session with the first user. Once again, a pop-up window may be opened on the second terminal of the second user. As a variant, the second user can be directly redirected to the second multimedia session shared with the first user.

According to certain embodiments, the first server is an IP telephony, videoconferencing or instant messaging server. The second server itself may be a networked game platform and the second multimedia session is thus a game session.

In some embodiments, the identifier of the first user and the identifier of the second user are respectively an IP address of the first terminal and an IP address of the second terminal.

Thus, the identifier of a user can be obtained in a way that is transparent to the user.

In addition, the first session is set up between a third terminal of the first user and a fourth terminal of the second user, respectively. The third terminal and the first terminal may be connected to one and the same local area network, on the one hand, and the fourth terminal and the second terminal may be connected to one and the same local area network, on the other hand.

In fact, sessions can thus be created from a game console, form a laptop computer or from a desktop computer, all these terminals being linked to one and the same local area network driven by a gateway having a unique IP address for example.

As a variant, the first session may be set up between the first terminal and the second terminal.

Thus, a number of sessions may be generated from a single terminal for each user. The users can thus, from their desktop computer for example, easily create photo-sharing sessions, while chatting via an instant messaging server for example.

A second aspect of the invention relates to a computer program product comprising program code instructions stored on a computer-readable medium, for executing the steps of the method according to the embodiments of the first aspect of the invention.

A third aspect of the invention refers to a server for creating a plurality of multimedia sessions between a first and a second user. The server comprises:
a first unit for receiving a connection request from the first terminal comprising an identifier of the first user;
a unit for transmitting the identifier of the first user to another server in order to request at least an identifier of a user sharing the first multimedia session with the first user via the other server;
a second unit for receiving at least an identifier of the second user; and
a unit for creating a second multimedia session between the first terminal of the first user and a second terminal of the second user via the server.

A fourth aspect of the invention relates to a system for creating a plurality of multimedia sessions between a first and a second user, the system comprising a first server for setting up a first multimedia session between the first and second users. The system also comprises a second server which comprises:
a first unit for receiving a connection request from the first terminal comprising an identifier of the first user;
a unit for transmitting the identifier of the first user to the first server in order to request at least an identifier of a user sharing the first multimedia session with the first user via the first server;
a second unit for receiving at least an identifier of the second user; and
a unit for creating a second multimedia session between the first terminal of the first user and the second terminal of the second user via the second server;
   The first server may comprise:
a unit for receiving the identifier of the first user from the second server;
a unit for determining identifiers of users sharing the first session with the first user via the second server;
a unit for transmitting to the second server at least an identifier of the second user.

### BRIEF DESCRIPTION OF THE DRAWINGS

Other features and advantages of the present invention will become apparent from the following detailed description, given with reference to the appended drawings in which:

FIG. 1 presents a multimedia system according to an embodiment of the invention;

FIG. 2 is a diagram of steps representing the exchanges between a first and a second user during the creation of multimedia sessions according to an embodiment of the invention;

FIG. 3 presents the steps of a method according to an embodiment of the invention;

FIG. 4 presents two multimedia servers designed to communicate together, according to certain embodiments of the invention.

### DETAILED DESCRIPTION

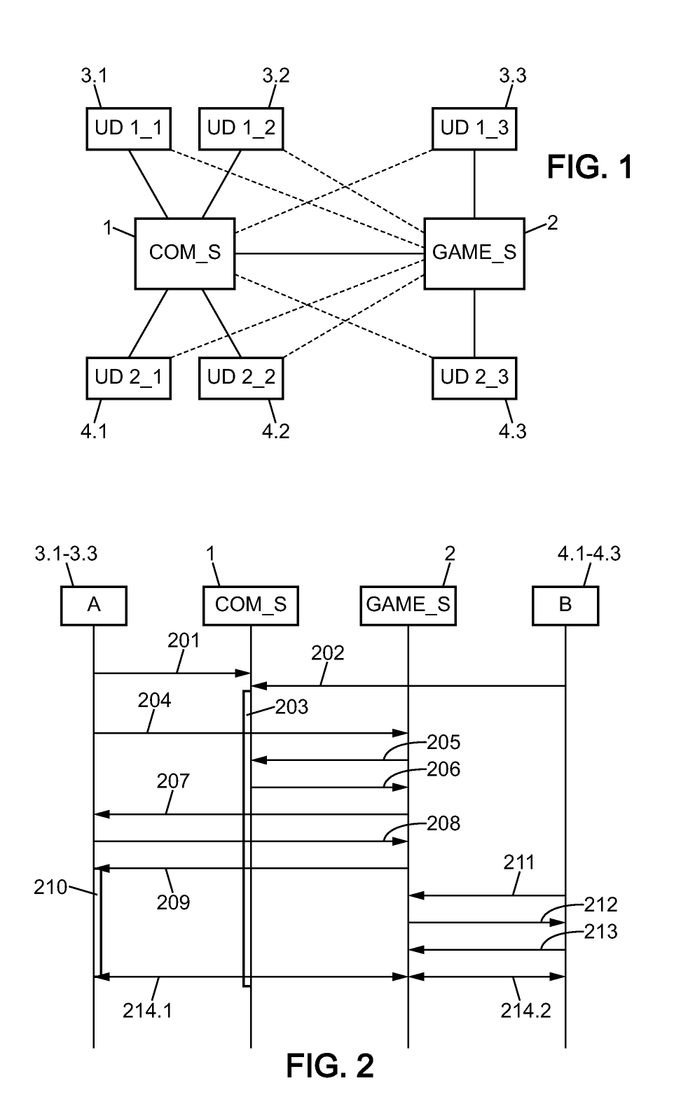

FIG. 1 presents a multimedia system according to an embodiment of the invention. The system comprises a first synchronous communication server 1 and a second synchronous communication server 2. In what follows, it is considered that the first server 1 may be, for example, a VOIP (Voice Over Internet Protocol) server, an instant messaging (IM) server or a videoconferencing server. It can also be considered that the second server 2 is, for example, a networked game platform, accessible via the Internet network. However, no restriction is attached to the first server 1 or to the second server 2 within the meaning of the invention. It may, for example, also be a server for sharing multimedia files such as videos, photos or music.

The first server 1 and the second server 2 are accessible to a first user and to a second user via first user terminals 3.1, 3.2 and 3.3 and via second user terminals users 4.1, 4.2 and 4.3, respectively.

For example, the first and second users can access the first server 1 via a mobile telephone such as a Smartphone in the case where the first server 1 is a videoconferencing server or an instant messaging server for example. The first and second users can also access the first server 1 via a desktop computer or a laptop computer with instant messaging or videoconferencing applications installed thereon. If the first server 1 is a VOIP server, the first and second users can also communicate via a fixed line telephone.

Thus, the user terminals 3.1, 3.2, 4.1 and 4.2 can be mobile telephones, desktop computers, laptop computers or fixed line telephones. No restriction is attached to the type of user terminals considered.

Similarly, the user terminals 3.3 and 4.3 allowing access to the second server 2 (in the case where it is a multi-player game server for example), may be Smartphones, laptop computers or desktop computers, or even a game console allowing network access for example.

It should be noted that the user terminal (or several user terminals) of the first or of the second user can both communicate with the first server 1 and with the second server 2 (dotted lines in FIG. 1). For example, a laptop computer linked to the Internet network can both allow for the installation of instant messaging applications (multimedia session on the first server 1) and the installation of a game making it possible to set up a multi-player session on the second server 2.

According to the invention, an identifier is associated with each user. For example, it may be an IP address associated with the different terminals that a user owns, which makes it possible to make the transmission of an identifier of the user transparent because it is known from the terminals. As a variant, the identifier may be communicated by a conventional identification/authentication system. Each of the terminals of one and the same user can thus be recognized by the identifier of that user.

The invention will be better understood in light of FIG. 2, which presents a flow diagram of steps executed by the elements of the system described with reference to FIG. 1.

With reference to FIG. 2, the interactions between the terminals 3.1-3.3 of the first user, the terminals 4.1-4.3 of the second user, the first server 1 and the second server 2 are considered. The terminals 3.1-3.3 of the first user are grouped together under one and the same entity, for the purposes of simplicity, which is also the case of the terminals 4.1-4.3 of the second user. However, as explained previously, the different sessions may be set up from different terminals for each user.

In a step 201, the first user connects to the first server 1 via one of the terminals 3.1-3.3 (for example, the terminal 3.1), which is an instant messaging server hereinafter in the description. The terminal 3.1 is identified to the instant messaging server 1 by the IP address of the first user, which is common to the terminals 3.1, 3.2 and 3.3.

In a step 202, the second user connects to the first server 1, via the terminal 4.2 for example. Once again, the second user is identified to the instant messaging server 1 by the IP address of the second user, which is common to the terminals 3.1, 3.2 and 3.3.

In a step 203, the first user and the second user can converse via the first server 1.

In a step 204, the first user connects to the second server 2, which is a game server hereinafter in the description, via the terminal 3.3 for example. To this end, the terminal 3.3 can send a connection request from the first user which comprises an identifier of the first user such as the IP address of the first user. The connection can also be set up by implementing an identification/authentication procedure, in which an identifier and a password are transmitted to the second server 2. Complementing the identifier of a user with an identifier/password combination may make it possible to open a multimedia session between two users sharing the same IP address. Thus, if two users are located in the same apartment and access the Internet network via the same Set Top Box, they can be differentiated by an identifier/password combination.

The second server 2 then queries the first server 1, in a step 205, in order to know whether an instant messaging session is set up between the first user and another user, via the first server 1. By querying the first server 1, the second server 2 also transmits the identifier of the first user which was received in the connection request. The first server 1, which knows the sessions that are in progress, can then confirm that the session initiated in the step 203 is still active, and that this session is set up between the first user, whose identifier has been received, and the second user, whose identifier is known from the first server 1.

The identifier of the second user is then transmitted in a step 206 to the second server 2. If, on the contrary, no one is communicating with the first user, or else if a status of the instant messaging session or of one of the users is marked “busy”, “absent” or “offline” for example, the first server 1 can indicate to the second server 2 that the first user is not communicating with anyone via the first server 1. A standard game session can then be initiated on the second server 2.

Furthermore, the first user may have a plurality of instant messaging sessions which are active simultaneously, with a plurality of users. In this case, the first server 1 can communicate to the second server all the identifiers of the users with whom the first user is communicating via the instant messaging session. Hereinbelow, it is considered that the instant messaging session via the first server 1 is still active and that only the second user is sharing an instant messaging multimedia session with the first user via the first server 1.

Once the second server 2 has received the identifier of the second user, it can send a query message to the terminal 3.3 of the first user, in a step 207, this query message comprising the identifier of the second terminal. Furthermore, the second server 2 can store, in association, the identifiers of the first user and of the second user in a memory, temporarily for example.

On reception of the query message, the terminal 3.3 can generate a pop-up window, by virtue of which the first user is queried concerning his or her desire to set up, or not set up, a second session with the second user via the second server 2. In the case where the first user does not want to play with the second user, the terminal 3.3 returns a rejection message to the second server 2 and the second server 2 then initiates a standard game session, in which the first user plays alone. As a variant, the second server 2 may propose to initiate a multi-player session with users with whom the first user is not currently communicating via the first server 1.

In the contrary case where the first user wants to create a multi-player session with the second user, the terminal 3.3 sends an acceptance message to the second server 2 in a step 208.

The second server then initiates a multi-player game session in a step 209. The terminal 3.3 launches a multi-player game interface in a step 210 in order for the first user to wait while the second user joins the multi-player session.

In a step 211, the second user connects to the second server, via the terminal 4.3 for example. To this end, the terminal 4.3 sends a connection request to the second server 2, the connection request comprising an identifier of the second user.

On reception of the connection request from the terminal 4.3, the second server 2 determines whether another user has initiated a game session to which the second user has been invited. To this end, the second server can consult the memory in order to know whether an identifier is associated with the identifier of the second user received. In the example described, the first user has accepted to create a game session with the second user. Thus, the second server 2 sends a query message in a step 212 to the terminal 4.3 of the second user.

On reception of the query message, the terminal 4.3 can generate a pop-up window, by virtue of which the second user is queried as to his desire to join, or not join, the multi-player session created by the first user. In the case where the second user refuses to participate in the multi-player game session initiated by the first user, a rejection message is sent by the terminal 4.3 to the second server 2 and, in this case, a standard game session (single-player) is launched for the second user. If the second user is the only user with whom the first user has accepted to create a second multimedia session, the multi-player game interface launched in the step 210 is replaced by a standard game session. On the other hand, if other users are awaiting acceptance or rejection, the multi-player game interface launched in the step 210 is maintained pending the acceptance of another user.

In what follows, it is considered that the second user accepts joining the multi-player game session initiated by the first user. An acceptance message is then sent in a step 213 by the terminal 4.3 to the second server 2.

The multi-player game session is then launched by the second server 2. The terminals 3.3 and 4.3 then communicate via the second server during steps 214.1 and 214.2 respectively.

No restriction is attached to the order in which the steps dependent on the first user and those dependent on the second user follow one another. In practice, the terminal 4.3 of the second user may send the connection request of the step 211 at any moment (when the second user wants to). If this request is sent before the connection request from the first user (before the step 204), or during the creation of the multi-player game session by the first user, then the second user can also initiate a multi-player game session. Thus, the first user and the second user may possibly each create a multi-player session simultaneously. When one of the sessions is created, the creation of the second can be interrupted in order to send the query message of the step 212 to the user who has not finished creating the multi-player session for example.

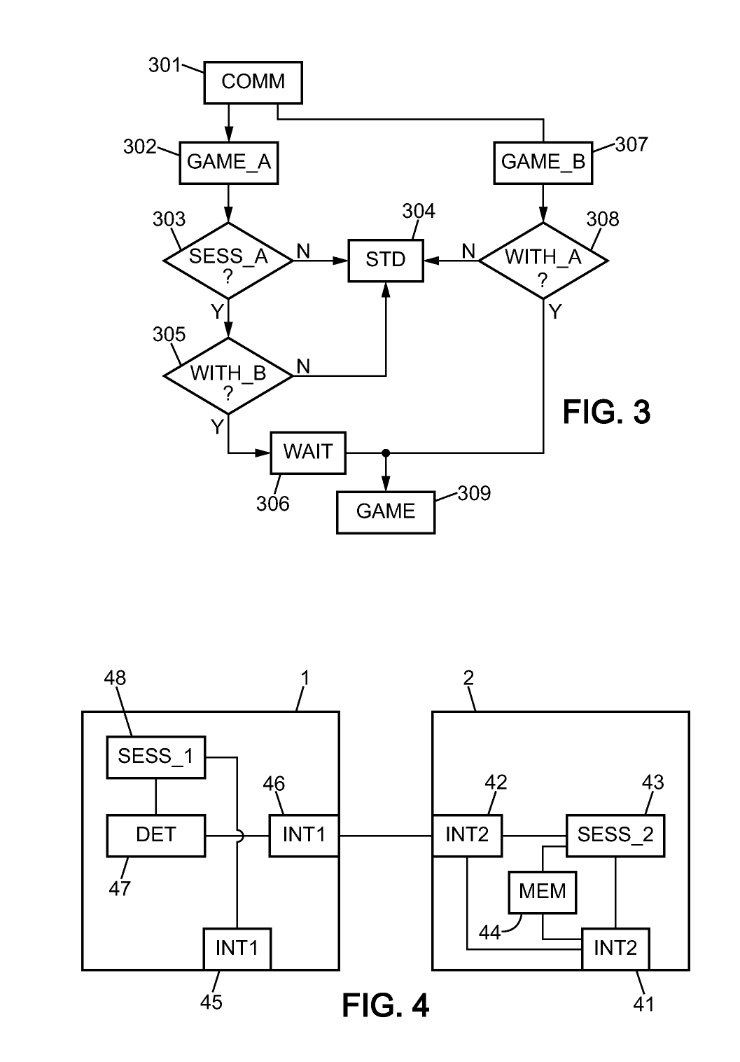

FIG. 3 presents the steps of a method according to an embodiment of the invention.

In a step 301, the first user and the second user are initially communicating via a multimedia session on the first server 1.

In a step 302, the first user connects to the second server 2 by sending via the terminal 3.3 a connection request to the second server 2, as explained previously.

In a step 303, the second server 2 queries the first server 1 in order to determine whether a multimedia session is set up between the first user and another user, by sending the identifier of the first user received in the connection request. If the first user has no multimedia session in progress via the first server 1 (or if the status of the session or of the user is “busy”, “offline” or “absent” for example), a standard game session can be initiated by the second server 2 in a step 304.

In a step 305, the first user, on reception of the query message described previously, can choose whether or not to initiate a multi-player game session with the second user from a pop-up window displayed on the terminal 3.3. If the first user refuses, a standard game session can be initiated in the step 304. If the first user accepts, he or she is made to wait in a step 306 during which a multi-player game interface may be displayed on the terminal 3.3 of the first user.

In a step 307, the terminal 4.3 of the second user sends a connection request to the second server 2, the connection request comprising the identifier of the second user. As explained previously, the step 307 is not necessarily after the steps 302 to 306 which apply to the first user.

The second server 2 then proposes launching a multi-player game session, between at least the first user and the second user, whose identifiers have been associated in a memory internal to the second server, by sending a query message in a step 308 to the terminal 4.3 of the second user. In the case where the second user, when the pop-up window displayed on the terminal 4.3 offers him or her a multi-player game session with the first user, refuses to join the multi-player session, a standard game session can be initiated by the second server 2 in a step 304.

In the case where the second user accepts the multi-player game session with the first user, the multi-player game session is then launched by the second server 2 in a step 309.

FIG. 4 presents the structure of the servers 1 and 2 introduced previously with reference to the preceding figures, according to certain embodiments of the invention.

The second server 2 comprises a first communication interface 41 with user terminals, notably including the terminals 3.1 to 3.3 and 4.1 to 4.3 of the first user and of the second user, respectively. The communication interface 41 comprises, at the same time, a first reception unit for receiving connection requests, a unit for transmitting query messages and unit for receiving rejection or acceptance messages as previously introduced. The second server also comprises a second communication interface 42 with other servers, such as the first server 1 for example. The second communication interface comprises a unit for transmitting user identifiers in order to request at least an identifier of another user sharing a session with the user or the users whose identifiers have been transmitted and a unit for receiving the requested identifiers.

In order to store, in association, the identifiers of the users who are sharing one and the same session via other servers, the second server also comprises a memory 44.

The second server 2 comprises a creation unit 43 making it possible to create multi-player game sessions from identifiers of users stored in association in the memory 44.

The first server 1 comprises a communication unit 45 with user terminals, such as the terminals 3.1 to 3.3 and 4.1 to 4.3 for example. The communication unit 45 of the first server 1 may be similar to the communication unit 41 of the second server 2. The communication unit 45 is linked to a unit 48 for managing sessions between users via the first server 1. The first server 1 comprises a communication interface 46 with other servers, and notably with the second server 2. The communication interface 46 comprises a unit for receiving user identifiers and a unit for transmitting identifiers of other users who are sharing a multimedia session with the users whose identifiers have been previously received. In order to determine the associations between the users who are sharing one and the same session via the first server 1, the first server also comprises a determination unit 47 making it possible to determine, from the identifier of a user, the identifiers of other users for whom a multimedia session is in progress with the identified user via the first server 1.

In the preceding examples, two servers have been considered, in the interest of simplicity. However, the invention can be implemented similarly between a larger number of servers, which can be mutually queried in order to request and supply identifiers of users communicating with other users.

The present invention thus makes it possible to simplify the path of a user in creating multimedia sessions by making it intuitive and transparent to the user. It thus makes it possible to avoid requesting the host user to assign a code to a multimedia session, a code that he or she must then communicate to other users in order for them to be able to join the multimedia session. In as much as the present invention also provides an automatic redirection of the other users to the multimedia session created, the path of the users who join the multimedia session is also simplified.

1. A method for creating a plurality of multimedia sessions between a first user and a second user, a first multimedia session being set up between said first and second users via a first server, wherein the method comprises the following steps implemented by a second server:
receiving a connection request from a first terminal of the first user comprising an identifier of the first user;
transmitting said identifier of the first user to the first server in order to request at least an identifier of a user sharing the first multimedia session with the first user via the first server;
receiving from the first server at least an identifier of said second user; and
creating a second multimedia session between the first terminal of the first user and a second terminal of the second user via the second server.

2. The method as claimed in claim 1, wherein the identifier of the second user is received if the first session is active.

3. The method as in claim 1, wherein the step of creation of a second multimedia session between the first terminal and the second terminal via the second server comprises:
transmitting the identifier of the second user to the first terminal in order to determine whether the first user wants to set up a multimedia session with the second user via the second server;
creating a second multimedia session between the first terminal and the second terminal via the second server,
said creation being conditional on the acceptance of the first user to set up a multimedia session with the second user via the second server.

4. The method as claimed in claim 1, wherein the creation of the second multimedia session between the first terminal and the second terminal via the second server is conditional on the reception by the second server of a connection request from the second terminal comprising an identifier of the second user.

5. The method as claimed in claim 4, wherein, on reception of the connection request from the second terminal comprising an identifier of the second user, the method also comprises the transmission of the identifier of the first user to the second terminal in order to determine whether the second user wants to set up a multimedia session with the first user via the second server and wherein creating a second multimedia session between the first terminal and the second terminal via the second server is conditional on the acceptance of the second user to set up a multimedia session with the first user via the second server.

6. The method as claimed in claim 1, wherein the first server is an IP telephony, videoconferencing or instant messaging server.

7. The method as claimed in claim 1, wherein the second server is a networked game platform and wherein the second multimedia session is a game session.

8. The method as claimed in claim 1, wherein the identifier of the first user and the identifier of the second user are respectively an IP address of the first terminal and an IP address of the second terminal.

9. The method as claimed in claim 8, wherein the first session is set up between a third terminal of the first user and a fourth terminal of the second user, respectively, wherein the third terminal and the first terminal, on the one hand, are linked to one and the same local area network, and wherein the fourth terminal and the second terminal, on the other hand, are linked to one and the same local area network.

10. The method as claimed in claim 8, wherein the first session is set up between the first terminal and the second terminal.

11. A non-transitory computer program product comprising program code instructions stored on a computer-readable medium, for executing the steps of the method as claimed in claim 1.

12. A server for creating a plurality of multimedia sessions between a first user and a second user, wherein the server comprises:
a first unit for receiving a connection request from the first terminal comprising an identifier of the first user;
a unit for transmitting said identifier of the first user to another server in order to request at least an identifier of a user sharing the first multimedia session with the first user via said other server;
a second unit for receiving at least an identifier of said second user; and
a unit for creating a second multimedia session between the first terminal of the first user and a second terminal of the second user via said server.

13. A system for creating a plurality of multimedia sessions between a first user and a second user, said system comprising a first server for setting up a first multimedia session between said first and second users, wherein said system also comprises a second server, said second server comprising:
a first unit for receiving a connection request from the first terminal comprising an identifier of the first user;
a unit for transmitting said identifier of the first user to the first server in order to request at least an identifier of a user sharing the first multimedia session with the first user via the first server;
a second unit for receiving at least an identifier of said second user; and
a unit for creating a second multimedia session between the first terminal of the first user and the second terminal of the second user via the second server;
and wherein the first server comprises:
a unit for receiving the identifier of the first user from said second server;
a unit for determining identifiers of users sharing the first session with the first user via the second server;
a unit for transmitting to the second server at least an identifier of the second user.
